(19) United States
(12) Patent Application Publication
(10) Pub. No.: US 2026/0245387 A1
(43) Pub. Date: Aug. 20, 2026

(54) METHOD FOR TRAINING IMAGE DESCRIPTION GENERATION MODEL, IMAGE DESCRIPTION GENERATION METHOD, DEVICE, MEDIUM, AND PRODUCT

(71) Applicant: GOERTEK Inc., Weifang (CN)

(72) Inventors: Jiujian SUN, Weifang (CN); Mingming Yang, Weifang (CN); Xudong Qiu, Weifang (CN); Chao Zhang, Weifang (CN); Guoxin Li, Weifang (CN)

(21) Appl. No.: 19/312,183

(22) Filed: Aug. 27, 2025

Related U.S. Application Data
(63) Continuation of application No. PCT/CN2025/090471, filed on Apr. 22, 2025.

(30) Foreign Application Priority Data
Feb. 18, 2025 (CN) 202510179565.9

(51) Int. Cl. G06V 20/70; G06F 40/30; G06F 40/58

(52) U.S. Cl. CPC G06V 20/70; G06F 40/30; G06F 40/58

(57) ABSTRACT

The present application provides a method for training an image description generation model, an image description generation method, a device, a medium and a product. The method includes: obtaining an image description generation model to be trained, an original vocabulary list and a newly added vocabulary library; for each newly added Chinese vocabulary in the newly added vocabulary library, searching the original vocabulary list for a target original vocabulary whose semantic similarity with the newly added Chinese vocabulary is greater than a preset threshold, and inserting the newly added Chinese vocabulary into a position adjacent to the target original vocabulary; until all the newly added Chinese vocabulary in the newly added vocabulary library are inserted into the original vocabulary list to obtain an expanded vocabulary list; training the image description generation model based on the expanded vocabulary list to obtain a trained image description generation model.

### CROSS-REFERENCE TO RELATED APPLICATIONS

The present application is a continuation application of International Application No. PCT/CN2025/090471, filed on Apr. 22, 2025, which claims priority to Chinese patent application No. 202510179565.9, entitled in “METHOD FOR TRAINING IMAGE DESCRIPTION GENERATION MODEL, IMAGE DESCRIPTION GENERATION METHOD, DEVICE, MEDIUM, AND PRODUCT” and filed on Feb. 18, 2025. The disclosures of the above-mentioned applications are incorporated herein by reference in their entireties.

### TECHNICAL FIELD

The present application relates to the technical field of machine learning, and in particular to a method for training an image description generation model, an image description generation method, a device, a medium and a product.

### BACKGROUND

Image description, or image annotation, is a technology that converts image content into natural language description. Image description is currently widely used in various scenarios, such as large-scale question answering, visual search, automatic image annotation, content recommendation, and assistance for people with visual impairments. The accuracy of image description is directly related to the effect and user experience of these applications, and has important practical significance.

The generation of image description is mostly achieved by using an image description generation model based on a deep learning framework, that is, the basic features of the image are extracted by the image description generation model, and the corresponding description sentences are generated according to the basic features to obtain the image description text. The training of the image description generation model often requires a large amount of training corpus, including training images and corresponding description sentences. However, the current models used for image description generation are usually trained based on English vocabulary, and the models only support English vocabulary. In Chinese scenarios, a translation network is needed to translate Chinese into English, and Chinese text cannot be directly processed, resulting in a significant decrease in the performance of the image description generation model in Chinese scenarios.

Therefore, how to improve the performance of the image description generation model in Chinese scenarios is a technical problem that needs to be solved in this technical field.

### SUMMARY

The main purpose of the present application is to provide a method for training an image description generation model, an image description generation method, a device, a medium and a product, aiming to solve the technical problem of how to improve the performance of the image description generation model in Chinese scenarios.

To achieve the above purpose, the present application provides a method for training an image description generation model, including:
obtaining an image description generation model to be trained, an original vocabulary list and a newly added vocabulary library; the newly added vocabulary library includes at least one newly added Chinese vocabulary, and the original vocabulary list includes at least one original vocabulary;
for each newly added Chinese vocabulary in the newly added vocabulary library, searching for a target original vocabulary whose semantic similarity with the newly added Chinese vocabulary is greater than a preset threshold in the original vocabulary list, and inserting the newly added Chinese vocabulary into a position adjacent to the target original vocabulary;
obtaining an expanded vocabulary list after all the newly added Chinese vocabulary in the newly added vocabulary library are inserted into the original vocabulary list; and
training the image description generation model based on the expanded vocabulary list to obtain a trained image description generation model.

In an embodiment, before the training the image description generation model based on the expanded vocabulary list, the method further includes:
initializing an embedding vector of each original vocabulary in the expanded vocabulary list; and
for each newly added Chinese vocabulary in the expanded vocabulary list, determining the embedding vector of the target original vocabulary adjacent to the newly added Chinese vocabulary as a target embedding vector, and initializing the embedding vector of the newly added Chinese vocabulary with the target embedding vector.

In an embodiment, the searching for the target original vocabulary whose semantic similarity with the newly added Chinese vocabulary is greater than the preset threshold in the original vocabulary list includes:
inputting the newly added Chinese vocabulary into a pre-trained translation network to obtain a translation vocabulary; and
comparing the semantic similarity between each original vocabulary in the original vocabulary list and the translation vocabulary, and searching for the target original vocabulary whose semantic similarity is greater than the preset threshold from each of the original vocabulary.

In addition, in order to achieve the above purpose, the present application provides an image description generation method, including:
obtaining an original image of an image description to be generated and a target image description generation model, and inputting the original image into the target image description generation model to obtain a description generation result;
the target image description generation model is an image description generation model trained by the method for training the image description generation mode.

In an embodiment, after the inputting the original image into the target image description generation model to obtain the description generation result, the method further includes:
retrieving target data matching the description generation result in a preset text retrieval database.

In an embodiment, the description generation result is output data of an output layer of the target image description generation model; the retrieving target data matching the description generation result in the preset text retrieval database includes:
performing vectorization processing on the description generation result to obtain a description vector, and retrieving a target index vector matching the description vector in a preset text retrieval database; and
determining stored data associated with the target index vector in the preset text retrieval database as retrieved target data.

In an embodiment, the description generation result is output data of an output layer of the target image description generation model; the retrieving target data matching the description generation result in the preset text retrieval database includes:
retrieving a target index vector matching the description generation result in the preset text retrieval database; and
determining stored data associated with the target index vector in the preset text retrieval database as retrieved target data.

In addition, in order to achieve the above purpose, the present application provides an electronic device, including: a memory, a processor, and a computer program stored on the memory and executable on the processor, the computer program being configured to implement the steps of the method.

In addition, in order to achieve the above purpose, the present application provides a readable storage medium; the readable storage medium is a computer-readable storage medium; the readable storage medium stores a computer program, and when the computer program is executed by a processor, the steps of the method are implemented.

In addition, in order to achieve the above purpose, the present application provides a computer program product, including: a computer program; when the computer program is executed by a processor, the steps of the method are implemented.

One or more technical solutions proposed in the present application have at least the following technical effects:
obtaining an image description generation model to be trained, an original vocabulary list and a newly added vocabulary library; the newly added vocabulary library includes at least one newly added Chinese vocabulary, and the original vocabulary list includes at least one original vocabulary; for each newly added Chinese vocabulary in the newly added vocabulary library, searching for a target original vocabulary whose semantic similarity with the newly added Chinese vocabulary is greater than a preset threshold in the original vocabulary list, and inserting the newly added Chinese vocabulary into a position adjacent to the target original vocabulary; obtaining an expanded vocabulary list after all the newly added Chinese vocabulary in the newly added vocabulary library are inserted into the original vocabulary list; and training the image description generation model based on the expanded vocabulary list to obtain a trained image description generation model. In this way, the embodiment of the present application inserts at least one newly added Chinese vocabulary into the original vocabulary list of the training image description generation model; that is, the image description generation model is trained by adding Chinese vocabulary into the vocabulary list, so that the model can directly process Chinese vocabulary, and no longer needs to use a translation network to translate Chinese into English, thereby improving the performance of the image description generation model in Chinese scenarios. Furthermore, the embodiment of the present application inserts the newly added Chinese vocabulary into the adjacent position of the target original vocabulary that is semantically close to it. It can be understood that, in the model, the embedding vector of the vocabulary is obtained by learning the context information. Putting semantically close vocabulary together can make these vocabulary more likely to be close to each other in the embedding space, which helps the model to better capture the semantic relationship between vocabulary during the training process and enhance the semantic understanding ability of the model, so as to further improve the performance of the image description generation model in the Chinese scenario. At the same time, this structure can reduce the model's dependence on specific vocabulary, so that the model can better handle polysemous vocabulary and vocabulary variants during the training process, enhance its adaptability in different contexts, and thus improve the generalization ability of the model.

### BRIEF DESCRIPTION OF THE DRAWINGS

The drawings herein are incorporated into the specification and constitute a part of the specification, showing embodiments consistent with the present application, and together with the specification, are configured to explain the principles of the present application.

In order to more clearly illustrate the technical solutions in the embodiments o the present application or the related art, the drawings required for use in the embodiments or the related art description will be briefly introduced below. Obviously, for those skilled in the art, other drawings can also be obtained based on these drawings without creative labor.

FIG. 1 is a schematic diagram of a traditional training process for training a BLIP model suitable for Chinese scenarios.

FIG. 2 is a schematic diagram of a traditional inference process using a BLIP model in Chinese scenarios.

FIG. 3 is a schematic diagram of a process of a method for training an image description generation model according to a first embodiment of the present application.

FIG. 4 is a brief schematic diagram of a process of the method for training th image description generation model of the present application.

FIG. 5 is a schematic diagram of a device structure of a device for training an image description generation model of the present application.

FIG. 6 is a schematic diagram of a device structure of a hardware operating environment involved in the method and device for training the image description generation model according to an embodiment of the present application.

The realization of the purpose, functional features and advantages of the present application will be further explained in conjunction with embodiments and with reference to the accompanying drawings.

### DETAILED DESCRIPTION OF THE EMBODIMENTS

In order to make the above-mentioned purposes, features and advantages of the present application more obvious and easy to understand, the technical solutions in the embodiments of the present application will be described clearly and completely in combination with the drawings in the embodiments of the present application. Obviously, the described embodiments are only part of the embodiments of the present application, not all of them. Based on the embodiments of the present application, all other embodiments obtained by those skilled in the art without creative work belong to the protection scope of the present application.

Traditional image description generation models, such as the bootstrapping language-image pre-training (BLIP) model, are trained on English data sets, which will lead to the situation that many vocabulary that are not in the vocabulary of the model in Chinese tasks cannot be recognized, which in turn leads to poor performance of the model in Chinese scenarios.

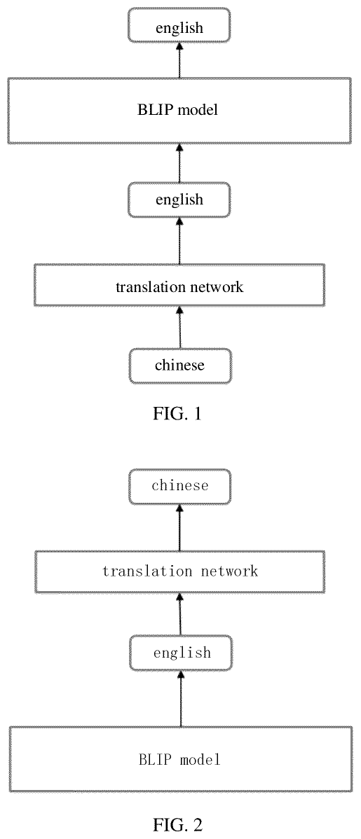

In the traditional way, in the Chinese scenario, a translation network needs to configured to translate Chinese into English so that the model can indirectly process Chinese. For example, as shown in FIG. 1, in the training stage, a translation network needs to be configured to translate the Chinese training label into English, and then the BLIP model is trained with the English translated as the training label of the BLIP model; as shown in FIG. 2, in the inference stage, the output of the BLIP model needs to be converted into Chinese using a translation network. There are at least two problems with this indirect way of processing Chinese: First, the model becomes larger and the inference speed becomes slower due to the addition of a translation network to the model. Second, in the process of translating between English and Chinese, some semantics will be lost, thereby weakening the ability of the model and significantly reducing the performance of the model in the Chinese scenario.

Based on this, the main solution of the present application is: obtaining the image description generation model to be trained, the original vocabulary list and the newly added vocabulary library; the newly added vocabulary library includes at least one newly added Chinese vocabulary, and the original vocabulary list includes at least one original vocabulary; for each newly added Chinese vocabulary in the newly added vocabulary library, finding the target original vocabulary in the original vocabulary list whose semantic similarity with the newly added Chinese vocabulary is greater than a preset threshold, and inserting the newly added Chinese vocabulary into a position adjacent to the target original vocabulary; until all the newly added Chinese vocabulary in the newly added vocabulary library are inserted into the original vocabulary list to obtain an expanded vocabulary list; training the image description generation model based on the expanded vocabulary list to obtain the trained image description generation model. Thus, the embodiment of the present application inserts at least one newly added Chinese vocabulary into the original vocabulary list of the trained image description generation model, that is, trains the image description generation model by adding Chinese vocabulary into the vocabulary list, so that the model can directly process Chinese vocabulary, and no longer needs to use a translation network to translate Chinese into English, thereby improving the performance of the image description generation model in Chinese scenarios. Furthermore, the present application inserts the newly added Chinese vocabulary into the adjacent position of the target original vocabulary that are semantically close to it. It can be understood that, in the model, the embedding vector of the vocabulary is learned through context information. Putting semantically close vocabulary together can make these vocabulary more likely to be close to each other in the embedding space, which helps the model better capture the semantic relationship between vocabulary during the training process, improves the semantic understanding ability of the model, and further improves the performance of the image description generation model in Chinese scenarios. At the same time, this structure can reduce the model's dependence on specific vocabulary, so that the model can better handle polysemous vocabulary and vocabulary variants during the training process, enhance its adaptability in different contexts, and thus improve the generalization ability of the model.

It should be noted that the execution subject of each embodiment of the method for training the image description generation model of the present application can be a computing service device with data processing, model communication and program running functions, such as a server, a tablet computer, a personal computer, a mobile phone, etc., or an electronic device capable of realizing the above functions, such as a robot, etc. The embodiments of the method for training the image description generation model of the present application do not make specific restrictions on this.

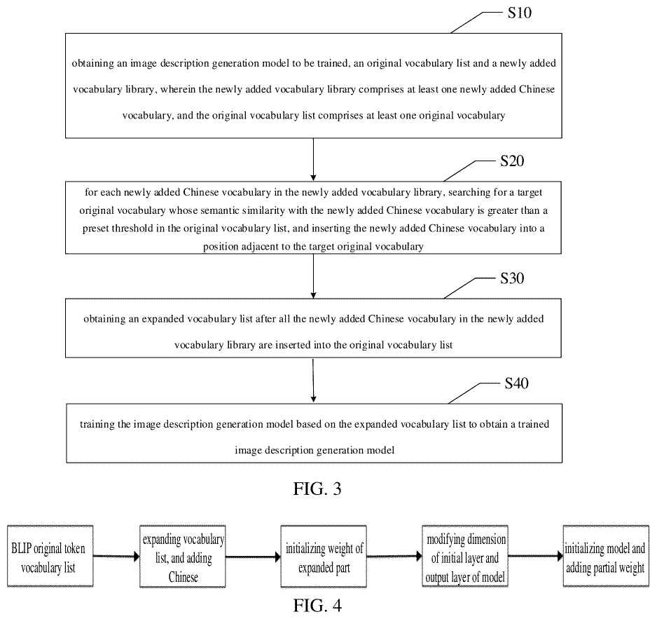

Based on this, the present application proposes the method for training the image description generation model of the first embodiment, as shown in FIG. 3, the method for training the image description generation model includes the following steps S10~S40:
Step S10, obtaining an image description generation model to be trained, an original vocabulary list and a newly added vocabulary library; the newly added vocabulary library includes at least one newly added Chinese vocabulary, and the original vocabulary list includes at least one original vocabulary;

The image description generation model is a model for generating image descriptions, that is, a model for converting images into text descriptions, which can be a model built based on a deep learning architecture, such as a BLIP model, a contrastive language-image pre-training (CLIP) model, etc., and this embodiment does not make specific restrictions on this. Exemplarily, the image description generation model is used as a BLIP model to illustrate and describe the various embodiments of the present application.

The original vocabulary list is the vocabulary list currently used for training the BLIP model, such as the WordPiece vocabulary list, which contains the vocabulary set used by the model in the training stage. The original vocabulary in the original vocabulary list is usually common English vocabulary, subvocabulary, and some special tags. For example, the original vocabulary list may include common vocabulary such as “man”, “woman”, “tree”, “car”, and subvocabulary units such as “##ing”, “##ed”.

The newly added vocabulary library refers to a newly added vocabulary library, which contains at least one newly added Chinese vocabulary, and the newly added Chinese vocabulary is a vocabulary in Chinese. The newly added Chinese vocabulary in the newly added vocabulary library can be derived from a Chinese vocabulary list, such as a vocabulary used for training the Chinese bidirectional encoder representations from transformers (BERT) model, a professional terminology library, a user-defined vocabulary list (such as “Sun Wukong”, “Chang'e”, “Pantaoyuan”, “Dragon Palace”, etc. in the game application scenario), and dynamically crawled emerging vocabulary, etc. This embodiment does not make specific restrictions on this.

Step S20, for each newly added Chinese vocabulary in the newly added vocabulary library, searching for a target original vocabulary in the original vocabulary list whose semantic similarity with the newly added Chinese vocabulary is greater than a preset threshold, and inserting the newly added Chinese vocabulary into a position adjacent to the target original vocabulary;

It should be noted that if the target original vocabulary is not found in the original vocabulary list, that is, the target original vocabulary with a semantic similarity between the newly added Chinese vocabulary greater than the preset threshold does not exist in the original vocabulary list, then the newly added Chinese vocabulary can be inserted into any position in the original vocabulary list, such as inserting the newly added Chinese vocabulary into the tail of the original vocabulary list. If there are multiple original vocabulary in the original vocabulary list whose semantic similarity with the newly added Chinese vocabulary is greater than the preset threshold, the original vocabulary with the highest semantic similarity can be selected as the target original vocabulary, so as to place vocabulary with higher semantic similarity together, which helps the model to better handle semantic similarity tasks, such as vocabulary meaning similarity calculation and analogical inference.

After finding the target original vocabulary in the original vocabulary list, the newly added Chinese vocabulary is inserted into the position adjacent to the target original vocabulary, that is, the newly added Chinese vocabulary is inserted into the original vocabulary list at a position adjacent to the target original vocabulary. The position adjacent to the target original vocabulary may be a position before or after the target original vocabulary.

Step S30, until all the newly added Chinese vocabulary in the newly added vocabulary library are inserted into the original vocabulary list, obtaining an expanded vocabulary list;

After all the newly added Chinese vocabulary in the newly added vocabulary library are inserted into the original vocabulary list according to the semantic order, an expanded vocabulary list is obtained. That is, the expanded vocabulary list is a vocabulary obtained after all the newly added Chinese vocabulary are inserted into the original vocabulary list.

Step S40, training the image description generation model based on the expanded vocabulary list to obtain the trained image description generation model.

After obtaining the expanded vocabulary list, the BLIP model is trained based the expanded vocabulary list; if the preset training end condition is met during the training process, the trained BLIP model is obtained; if the preset training end condition is not met, the model parameters of the BLIP model are iteratively optimized until the preset training end condition is met.

The training end condition may be a condition set in advance, such as reaching predetermined number of iterations, the loss function value being lower than a predetermined threshold, the computing resources being exhausted, the time limit being reached, the accuracy reaching a predetermined threshold, etc.; and this embodiment does not make specific restrictions on this.

It is understandable that when training the BLIP model, images are also required as input, and the corresponding text descriptions are used as labels to train the BLIP model. Based on this, the BLIP model can be trained using an extended vocabulary and a preset image-text pair dataset. The image-text pair dataset includes multiple images and text descriptions corresponding to each image. In an embodiment, a public dataset such as the common objects in context (COCO) dataset can be selected, or it can be a dataset that relevant personnel can prepare in advance based on actual needs. This embodiment does not impose specific restrictions on this.

In this embodiment, an image description generation model to be trained, an original vocabulary list and a newly added vocabulary library are obtained; the newly added vocabulary library includes at least one newly added Chinese vocabulary, and the original vocabulary list includes at least one original vocabulary; for each newly added Chinese vocabulary in the newly added vocabulary library, a target original vocabulary whose semantic similarity with the newly added Chinese vocabulary is greater than a preset threshold is searched in the original vocabulary list, and the newly added Chinese vocabulary is inserted into a position adjacent to the target original vocabulary; until all the newly added Chinese vocabulary in the newly added vocabulary library are inserted into the original vocabulary list, an expanded vocabulary list is obtained; and the image description generation model is trained based on the expanded vocabulary list to obtain the trained image description generation model. In this way, in this embodiment, at least one newly added Chinese vocabulary is inserted into the original vocabulary list of the training image description generation model, that is, the image description generation model is trained by adding Chinese vocabulary to the vocabulary list, so that the model can directly process Chinese vocabulary, and no longer needs to use a translation network to translate Chinese into English, thereby improving the performance of the image description generation model in Chinese scenarios. Furthermore, this embodiment inserts the newly added Chinese vocabulary into the adjacent position of the target original vocabulary with similar semantics. It can be understood that, in the model, the embedding vector of the vocabulary is obtained by learning context information. Putting semantically similar vocabulary together can make these vocabulary more likely to be close to each other in the embedding space, which helps the model to better capture the semantic relationship between vocabulary during the training process and improve the semantic understanding ability of the model, so as to further improve the performance of the image description generation model in the Chinese scenario. At the same time, this structure can reduce the model's dependence on specific vocabulary, so that the model can better handle polysemous vocabulary and vocabulary variants during the training process, enhance its adaptability in different contexts, and thus improve the generalization ability of the model.

Based on the first embodiment of the present application, in the second embodiment of the present application, the same or similar content as the above-mentioned first embodiment can be referred to the above introduction, and will not be repeated later. On this basis, before the step of training the image description generation model based on the expanded vocabulary list, the method further includes:

Step A10, initializing the embedding vector of each original vocabulary in the expanded vocabulary list;

It should be noted that the embedding vector refers to a high-dimensional space vector to which the vocabulary is mapped in the Embedding layer of the BLIP model. For the original vocabulary in the expanded vocabulary list, that is, the vocabulary initially in the original vocabulary list, it can be initialized in the current way of initializing the embedding vector of the BLIP model. For example, before training the BLIP model, a pre-trained text encoder (such as BERT or its variant) will be loaded, and the BLIP model will use the vocabulary embedding layer in the pre-trained text encoder to initialize the embedding vector of each original vocabulary in the original vocabulary list.

Step A20, for each newly added Chinese vocabulary in the expanded vocabulary list, determining the embedding vector of the target original vocabulary adjacent to the newly added Chinese vocabulary as the target embedding vector, and initializing the embedding vector of the newly added Chinese vocabulary with the target embedding vector.

For the newly added Chinese vocabulary added to the original vocabulary list, the embedding vector of the newly added Chinese vocabulary is vectorized with the embedding vector of the target original vocabulary adjacent to the newly added Chinese vocabulary (that is, the target embedding vector). In an embodiment, for each newly added Chinese vocabulary, the distance between its embedding vector and the target embedding vector is less than a certain threshold. For example, the embedding vector of the newly added Chinese vocabulary can be initialized with the weighted average or nearby value of the target embedding vector, so that the two vocabulary are closer in the embedding space, thereby reducing the number of iterations during model training, accelerating model convergence, and improving model training efficiency.

In an embodiment, the dimension of the output vector of the last output layer the BLIP model is correspondingly modified to the list dimension of the extended vocabulary; the list dimension of the extended vocabulary list refers to the total number of vocabulary in the extended vocabulary list. For example, assuming that the extended vocabulary list contains m vocabulary in total, the dimension of the output vector of the last output layer of the BLIP model is correspondingly modified to m dimensions.

In an embodiment, for the initialization of the output vector weight of the last output layer of the BLIP model, a mean filling method can be adopted, that is, the mean of the initial weight values of all the original vocabulary in the original vocabulary list in the output vector is configured to fill the initial weight value corresponding to the newly added Chinese vocabulary in the output vector, so that the model parameters of the BLIP model are evenly distributed, the number of iterations during model training is reduced, and the training efficiency of the model is improved.

Based on the first embodiment and/or the second embodiment of the present application, in the third embodiment of the present application, the same or similar contents as those of the above-mentioned first and second embodiments can be referred to the above introduction, and will not be repeated later. On this basis, the step of searching for the target original vocabulary whose semantic similarity with the newly added Chinese vocabulary is greater than the preset threshold in the original vocabulary list includes:

Step B10, inputting the newly added Chinese vocabulary into the pre-trained translation network to obtain the translation vocabulary;

It should be noted that the translation network is configured to translate the newly added Chinese vocabulary into the translation vocabulary of the same language as the original vocabulary in the original vocabulary list. If the original vocabulary list contains original vocabulary belonging to multiple languages, the translation network will translate the newly added Chinese vocabulary into the translation vocabulary of the language with the highest proportion; the language with the highest proportion is the language with the highest proportion among the languages to which the original vocabulary in the original vocabulary list belong. For example, assuming that the language of all original vocabulary or more than half of the original vocabulary in the original vocabulary list is English, the translation network will translate the newly added Chinese vocabulary into English.

Step B20, comparing the semantic similarity between each original vocabulary the original vocabulary list and the translation vocabulary, and finding the target original vocabulary whose semantic similarity is greater than the preset threshold from each original vocabulary.

It can be understood that the calculation and acquisition of semantic similarity between the same language is more convenient and simple than the calculation and acquisition of semantic similarity between different languages. Based on this, in this embodiment, the translation network is configured to translate the target original vocabulary to obtain the translation vocabulary, so that the semantic similarity is compared based on the translation vocabulary of the same language as most of the original vocabulary, and then the target original vocabulary are found, which can improve the search efficiency of the target original vocabulary.

Exemplarily, in order to help understand the technical concept or technical principle of the method for training the image description generation model after combining this embodiment with the first embodiment and the second embodiment, a specific embodiment is now listed. In this specific embodiment, please refer to FIG. 4, the text encoder and decoder parts of the BLIP model are modified. First, the original vocabulary list of the English BLIP model text to token (vocabulary unit) is modified (the original token vocabulary shown in FIG. 4); specifically, Chinese vocabulary is added to the original vocabulary list to obtain an expanded vocabulary list (the expanded list shown in FIG. 4, adding Chinese); this part of Chinese vocabulary is taken from the vocabulary list of the Chinese BERT model, covering all Chinese vocabulary.

After adjusting the original vocabulary list, the weight of the corresponding Embedding layer in the model is modified. First, the Embedding dimension of the original model is modified to the list dimension of the expanded vocabulary list; and secondly, the weight of this part of the expanded dimension is initialized. The initialization strategy in this specific implementation uses the form of mean filling, and the mean comes from the mean of the Embedding weights of the same layer. Finally, the dimension of the final output layer of the text decoder of the modified model is also modified to the list dimension of the expanded vocabulary list, and the weight initialization also adopts the form of mean filling.

After the weights of the Embedding layer (the initial layer shown in FIG. 4) and the output layer in the BLIP model are initialized, the BLIP model is trained with the expanded vocabulary list to obtain the trained BLIP model.

It should be noted that the above examples are only configured to assist in understanding the present application and do not constitute a limitation on the method for training the image description generation model of the present application. More simple transformations based on this technical concept are all within the protection scope of the present application.

In addition, the embodiment of the present application also proposes an image description generation method, which includes the following step S100:
Step S100, obtaining the original image of the image description to be generated and the target image description generation model, and inputting the original image into the target image description generation model to obtain the description generation result;

The target image description generation model is an image description generation model trained by the method for training the image description generation model described in any of the above embodiments.

The execution subject of each embodiment of the image description generation method can be a computing service device with data processing, model communication and program running functions, such as a tablet computer, a personal computer, a mobile phone, etc., or an electronic device capable of realizing the above functions, such as augmented reality (AR) glasses, virtual reality (VR) glasses, AR helmets, VR helmets, smart glasses, headphones, etc. This embodiment does not make specific restrictions on this. Further, the execution subjects of the image description generation method of the present application and the method for training the image description generation model can be the same or different, and no specific restrictions are made here.

It is easy to understand that after obtaining the original image of the image description to be generated, the original image is input into the target image description generation model to obtain the description generation result, which can be specifically the output of the target image description generation model,

In a possible implementation, after the step of inputting the original image into the target image description generation model to obtain the description generation result, the method further includes:
Step S200, retrieving target data matching the description generation result in a preset text retrieval database.

The preset text retrieval database can be a database set in advance by relevant personnel, and can be a retrieval-augmented generation (RAG) database. RAG database is a vector database specifically configured to store and query high-dimensional vector data. It converts text data into vectors (embedded) and stores these vectors, so that the vector closest to the query vector can be efficiently retrieved, thereby finding relevant text content.

Considering that traditional RAG processes images using OCR or large model technology to parse out key information in the image, the text is encoded. However, when there is no text information in the image and the content of the image cannot be understood by the large model, the image will fail to enter RAG. Based on this, in an implementation, the preset text retrieval database is a RAG database, so that the image is converted into a corresponding text description through a fine-tuned BLIP model, and a subsequent RAG retrieval is performed based on the text, so as to realize the encoding of the image into the form of RAG and the low-cost retrieval of the image into the RAG database.

Considering that with the rapid growth of the types of smart AR+artificial intelligence (AI) glasses, it is becoming easier and easier to take images by smart devices. At the same time, with the emergence of visual large models, how to enable the large model to better understand the content in the image becomes very important. Generally speaking, the visual large model cannot achieve a detailed understanding of images in specific scenarios (such as game scenarios). To achieve a detailed understanding, it is necessary to train and fine-tune the visual large model, but the cost of fine-tuning the large model is very high. Based on this, in this embodiment, the target image description generation model is configured to generate a text description of the image, and then the text description is configured to search in the text retrieval database, so that the image can be searched in the text data, and an end-to-end large model+text retrieval solution is realized, thereby improving the visual ability boundary of the large model in a low-cost manner and better adapting to specific scenarios.

In a possible implementation, the description generation result is the output data of the output layer of the target image description generation model, and the step of retrieving the target data matching the description generation result in the preset text retrieval database includes:
Step S201, vectorizing the description generation result to obtain a description vector, and retrieving the target index vector matching the description vector in the preset text retrieval database;

It should be noted that the output layer specifically refers to the last layer network of the target image description generation model, which is intended to convert the internal feature representation of the model into the final prediction result, so that the model can directly output the explanation or prediction of the input data. The description generation result is the output data of the output layer of the target image description generation model, that is, the final output of the target image description generation model.

If the description generation result is the output data of the output layer of the target image description generation model, and the index of the preset text retrieval database is stored in a vector form, the description generation result is vectorized so that the target index vector is matched in the preset retrieval database by vector matching.

Vectorization refers to the process of converting data into a numerical vector. The specific processing method of vectorization processing can be preset. For example, the vectorization processing of data can be completed by embedding (such as Embedding network such as Text2Vec). Embedding processing generally refers to converting data from its original form into a low-dimensional, continuous vector representation that can capture the intrinsic characteristics and structure of the data.

Step S202, determining that the stored data associated with the target index vector in the preset text retrieval database is the retrieved target data.

The target data can specifically be the original text fragment corresponding to the target index vector stored in the preset text retrieval database.

In a possible implementation, the description generation result is the input data of the output layer of the target image description generation model, and the step of retrieving the target data matching the description generation result in the preset text retrieval database includes:

Step S203, retrieving the target index vector matching the description generation result in the preset text retrieval database;

It should be noted that the target image description generation result is the input data of the output layer of the target image description generation model, that is, the output of the penultimate network layer of the target image description generation model, such as the output of the language modeling (LM) layer of the BLIP model. At this time, it can be understood that the output of the penultimate network layer of the model is essentially vector mode data. Therefore, when the index of the preset text retrieval database is stored in a vector manner, there is no need to vectorize the description generation result, and the target index vector can be directly matched in the preset retrieval database based on the description generation result by vector matching.

Step S204, determining that the stored data associated with the target index vector in the preset text retrieval database is the retrieved target data.

Similarly, the target data can be specifically the original text fragment corresponding to the target index vector stored in the preset text retrieval database.

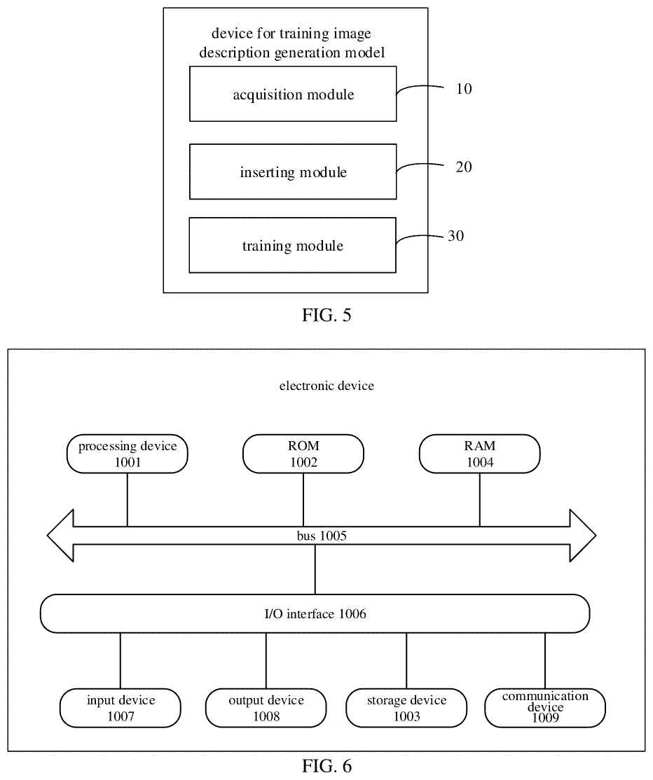

In addition, the embodiment of the present application also proposes a device training an image description generation model, as shown in FIG. 5, the device for training the image description generation model includes:
Acquisition module 10, configured to acquire the image description generation model to be trained, the original vocabulary list and the newly added vocabulary library; the newly added vocabulary library includes at least one newly added Chinese vocabulary, and the original vocabulary list includes at least one original vocabulary;
Inserting module 20, configured to search for the target original vocabulary in the original vocabulary list for each newly added Chinese vocabulary in the newly added vocabulary library, whose semantic similarity with the newly added Chinese vocabulary is greater than a preset threshold, and insert the newly added Chinese vocabulary into a position adjacent to the target original vocabulary;
Inserting module 20, also configured to obtain an expanded vocabulary list after all the newly added Chinese vocabulary in the newly added vocabulary library are inserted into the original vocabulary list;
Training module 30, configured to train the image description generation model based on the expanded vocabulary list to obtain the trained image description generation model.

In addition, the embodiment of the present application also proposes an electronic device, the electronic device including: a memory, a processor, and a computer program stored in the memory and executable on the processor, the computer program being configured to implement the steps of the method for training the image description generation model and/or the image description generation method as described above.

Referring to FIG. 6, a structural schematic diagram of an electronic device suitable for implementing the embodiment of the present application is shown. The electronic device in the embodiment of the present application may also include but is not limited to mobile terminals such as headphones, AR glasses, VR glasses, AR helmets, VR helmets, laptops, digital broadcast receivers, personal digital assistant (PDA), portable application description (PAD), portable media player (PMP), etc., and fixed terminals such as digital TV, desktop computers, etc. The electronic device shown in FIG. 6 is only an example and should not impose any restrictions on the functions and scope of use of the embodiment of the present application.

As shown in FIG. 6, the electronic device may include a processing device 1001 (e.g., a central processing unit, a graphics processor, etc.), which may perform various appropriate actions and processes according to a program stored in a read-only memory (ROM) 1002 or a program loaded from a storage device 1003 to a random access memory (RAM) 1004. Various programs and data required for the operation of the electronic device are also stored in the RAM 1004. The processing device 1001, the ROM 1002, and the RAM 1004 are connected to each other via a bus 1005. An input/output (I/O) interface 1006 is also connected to the bus. Generally, the following systems may be connected to the I/O interface 1006, including: an input device 1007, for example, a touch screen, a touch pad, a keyboard, a mouse, an image sensor, a microphone, an accelerometer, a gyroscope, etc.; an output device 1008, for example, a liquid crystal display (LCD), a speaker, a vibrator, etc.; a storage device 1003, for example, a magnetic tape, a hard disk, etc.; and a communication device 1009. The communication device 1009 can allow the electronic device to communicate with other devices wirelessly or wired to exchange data. Although the figure shows an electronic device with various systems, it should be understood that, it is not required to implement or have all the systems shown. More or fewer systems may be implemented or provided instead.

In particular, according to the embodiments disclosed in the present application, the process described above with reference to the flowchart can be implemented as a computer software program. For example, the embodiments disclosed in the present application include a computer program product, which includes a computer program carried on a computer-readable medium, and the computer program contains program code for executing the method shown in the flowchart. In such an embodiment, the computer program can be downloaded and installed from the model through the communication device, or installed from the storage device 1003, or installed from the ROM 1002. When the computer program is executed by the processing device 1001, the above functions defined in the method of the embodiment disclosed in the present application are executed.

The electronic device provided in the embodiment of the present application adopts the method for training the image description generation model and/or image description generation method in the above embodiment, which can solve the technical problem of how to improve the performance of the image description generation model in the Chinese scenario. Compared with the related art, the beneficial effects of the electronic device provided by the present application are the same as the beneficial effects of the method for training the image description generation model and/or image description generation method provided by the above embodiment, and the other technical features in the electronic device are the same as the features disclosed in the method of the previous embodiment, which will not be repeated here.

It should be understood that the various parts disclosed in the present application can be implemented by hardware, software, firmware or a combination thereof. In the description of the above implementation, specific features, structures, materials or characteristics can be combined in a suitable manner in any one or more embodiments or examples.

The above is only a specific implementation of the present application, but the protection scope of the present application is not limited thereto. Those skilled in the art can easily think of changes or replacements within the technical scope disclosed in the present application, which should be covered within the protection scope of the present application. Therefore, the protection scope of the present application shall be subject to the protection scope of the claims.

In addition, to achieve the above purpose, the present application embodiment also provides a readable storage medium having computer-readable program instructions (i.e., computer programs) stored thereon, and the computer-readable program instructions are configured to execute the method for training the image description generation model and/or image description generation method in the above embodiment.

The computer-readable storage medium provided in the embodiment of the present application may be, for example, a USB flash drive, but is not limited to electrical, magnetic, optical, electromagnetic, infrared, or semiconductor systems, systems or devices, or any combination of the above. More specific examples of computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this embodiment, the computer-readable storage medium may be any tangible medium containing or storing a program that can be used by or in conjunction with an instruction execution system, system or device. The program code contained on the computer-readable storage medium may be transmitted using any appropriate medium, including but not limited to: wires, optical cables, radio frequency (RF), etc., or any suitable combination of the above.

The computer-readable storage medium may be included in the electronic device; or it may exist independently without being assembled into the electronic device.

The computer-readable storage medium carries one or more programs. When the one or more programs are executed by the electronic device, the electronic device: obtains the image description generation model to be trained, the original vocabulary list and the newly added vocabulary library; the newly added vocabulary library includes at least one newly added Chinese vocabulary, and the original vocabulary list includes at least one original vocabulary; for each newly added Chinese vocabulary in the newly added vocabulary library, finds the target original vocabulary in the original vocabulary list whose semantic similarity with the newly added Chinese vocabulary is greater than a preset threshold, and inserts the newly added Chinese vocabulary into a position adjacent to the target original vocabulary; until all the newly added Chinese vocabulary in the newly added vocabulary library are inserted into the original vocabulary list, obtains an expanded vocabulary list; trains the image description generation model based on the expanded vocabulary list to obtain the trained image description generation model.

Computer program code for performing the operations of the present application may be written in one or more programming languages or a combination thereof, including object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of model, including a local area network (LAN) or a wide area network (WAN), or may be connected to an external computer (e.g., via the Internet using an Internet service provider).

The flowcharts and block diagrams in the accompanying drawings illustrate the possible architecture, functions, and operations of the systems, methods, and computer program products according to various embodiments of the present application. In this regard, each box in a flowchart or block diagram may represent a module, a program segment, or a portion of a code that contains one or more executable instructions for implementing a specified logical function. It should also be noted that in some alternative implementations, the functions marked in the box may also occur in a different order than that marked in the accompanying drawings. For example, two boxes represented in succession may actually be executed substantially in parallel, and they may sometimes be executed in the opposite order, depending on the functions involved. It should also be noted that each box in a block diagram and/or flowchart, and a combination of boxes in a block diagram and/or flowchart, may be implemented by a dedicated hardware-based system that performs a specified function or operation, or may be implemented by a combination of dedicated hardware and computer instructions.

The modules described in the embodiments of the present application may be implemented by software or by hardware. Among them, the name of the module does not constitute a limitation on the module itself in some cases.

The readable storage medium provided in the present application is a computer-readable storage medium, which stores computer-readable program instructions (i.e., computer programs) for executing the above-mentioned method for training the image description generation model and/or image description generation method, and can solve the technical problem of how to improve the performance of the image description generation model in Chinese scenarios. Compared with the related art, the beneficial effects of the computer-readable storage medium provided in the present application are the same as the beneficial effects of the method for training the image description generation model and/or image description generation method provided in the above-mentioned embodiments, which are not described in detail here.

In addition, the embodiment of the present application also proposes a computer program product, including a computer program, which implements the steps of the above-mentioned method for training the image description generation model and/or image description generation method when executed by a processor.

The specific implementation method of the computer program product of the present application is basically the same as the above-mentioned embodiments of the method for training the image description generation model and/or image description generation method, which are not described in detail here.

It should be noted that, in this article, the terms “include”, “comprise” or any other variants thereof are intended to cover non-exclusive inclusion, so that a process, method, article or system including a series of elements includes not only those elements, but also other elements not explicitly listed, or also includes elements inherent to such process, method, article or system. In the absence of further restrictions, an element defined by the sentence “includes one . . . ” does not exclude the existence of other identical elements in the process, method, article or system including the element.

The serial numbers of the embodiments of the present application are only for description and do not represent the advantages and disadvantages of the embodiments.

Through the description of the above implementation methods, those skilled in the art can clearly understand that the above embodiment methods can be implemented by means of software plus the necessary general hardware platform, and of course by hardware, but in many cases the former is a better implementation method. Based on this understanding, the technical solution of the present application is essentially or the part that contributes to the related art can be embodied in the form of a software sensor, which is stored in a storage medium (such as ROM/RAM, disk, optical disk) as described above, and includes several instructions for a terminal device (which can be a mobile phone, computer, server or model device, etc.) to execute the methods described in each embodiment of the present application.

The above description is only some embodiments of the present application, and does not limit the patent scope of the present application. All equivalent structural changes made by using the contents of the present application specification and drawings under the inventive concept of the present application, or directly/indirectly applied in other related technical fields, are included in the protection scope of the present application.

What is claimed is:

1. A method for training an image description generation model, comprising:
obtaining an image description generation model to be trained, an original vocabulary list and a newly added vocabulary library, wherein the newly added vocabulary library comprises at least one newly added Chinese vocabulary, and the original vocabulary list comprises at least one original vocabulary;
for each newly added Chinese vocabulary in the newly added vocabulary library, searching for a target original vocabulary whose semantic similarity with the newly added Chinese vocabulary is greater than a preset threshold in the original vocabulary list, and inserting the newly added Chinese vocabulary into a position adjacent to the target original vocabulary;
obtaining an expanded vocabulary list after all the newly added Chinese vocabulary in the newly added vocabulary library are inserted into the original vocabulary list; and
training the image description generation model based on the expanded vocabulary list to obtain a trained image description generation model.

2. The method for training the image description generation model according to claim 1, wherein before the training the image description generation model based on the expanded vocabulary list, the method further comprises:
initializing an embedding vector of each original vocabulary in the expanded vocabulary list; and
for each newly added Chinese vocabulary in the expanded vocabulary list, determining the embedding vector of the target original vocabulary adjacent to the newly added Chinese vocabulary as a target embedding vector, and initializing the embedding vector of the newly added Chinese vocabulary with the target embedding vector.

3. The method for training the image description generation model according to claim 1, wherein the searching for the target original vocabulary whose semantic similarity with the newly added Chinese vocabulary is greater than the preset threshold in the original vocabulary list comprises:
inputting the newly added Chinese vocabulary into a pre-trained translation network to obtain a translation vocabulary; and
comparing the semantic similarity between each original vocabulary in the original vocabulary list and the translation vocabulary, and searching for the target original vocabulary whose semantic similarity is greater than the preset threshold from each of the original vocabulary.

4. An image description generation method, comprising:
obtaining an original image of an image description to be generated and a target image description generation model, and inputting the original image into the target image description generation model to obtain a description generation result;
wherein, the target image description generation model is an image description generation model trained by the method for training the image description generation model according to claim 1.

5. The image description generation method according to claim 4, wherein after the inputting the original image into the target image description generation model to obtain the description generation result, the method further comprises:
retrieving target data matching the description generation result in a preset text retrieval database.

6. The image description generation method according to claim 5, wherein the description generation result is output data of an output layer of the target image description generation model; the retrieving target data matching the description generation result in the preset text retrieval database comprises:
performing vectorization processing on the description generation result to obtain a description vector, and retrieving a target index vector matching the description vector in a preset text retrieval database; and
determining stored data associated with the target index vector in the preset text retrieval database as retrieved target data.

7. The image description generation method according to claim 5, wherein the description generation result is output data of an output layer of the target image description generation model; the retrieving target data matching the description generation result in the preset text retrieval database comprises:
retrieving a target index vector matching the description generation result in the preset text retrieval database; and
determining stored data associated with the target index vector in the preset text retrieval database as retrieved target data.

8. An electronic device, comprising: a memory, a processor, and a computer program stored on the memory and executable on the processor, the computer program being configured to implement the steps of the method according to claim 1.

9. A readable storage medium, wherein the readable storage medium is a computer-readable storage medium; the readable storage medium stores a computer program, and when the computer program is executed by a processor, the steps of the method according to claim 1 are implemented.

10. A computer program product, comprising: a computer program, wherein when the computer program is executed by a processor, the steps of the method according to claim 1 are implemented.
